(19) United States
(12) Patent Application Publication
(10) Pub. No.: US 2026/0217141 A1
(43) Pub. Date: Jul. 30, 2026

(54) SYSTEM AND METHOD FOR WIRELESS POWER FACTOR CORRECTED AC POWER DELIVERY WITHOUT AN ACTIVE GRID-SIDE CONVERTER

(71) Applicant: B. G. NEGEV TECHNOLOGIES AND APPLICATIONS LTD, Beer Sheva (IL)

(72) Inventors: Alon KUPERMAN, BEER SHEVA (IL); Andrey VULFOVICH, BEER SHEVA (IL); Yegal DARHOVSKY, BEER SHEVA (IL); Vladimir YUHIMENKO, BEER SHEVA (IL)

(21) Appl. No.: 19/145,202

(22) PCT Filed: Jan. 3, 2024
(86) PCT No.: PCT/IB2024/050043

§ 371 Date: Jul. 2, 2025

Related U.S. Application Data
(60) Provisional application No. 63/436,696, filed on Jan. 3, 2023.

(51) Int. Cl. B60L 53/122; B60L 53/20; H02M 1/42

(52) U.S. Cl. CPC B60L 53/122; B60L 53/20; H02M 1/4225; B60L 2210/10; B60L 2210/40

(57) ABSTRACT

Embodiments pertain to a wireless power transfer (WPT) system including: a wireless power transfer link (WPTL); and on a load-side of the WPTL, a high frequency (HF) rectifier positioned between the WPTL and a load, wherein the load includes a low frequency (LF) power factor correction rectifier and a current shaping DC/DC converter. The high frequency rectifier may be connected in series to the LF power factor correction rectifier via an HF bypass capacitor. The WPTL may be operated in load independent voltage output (LIVO) mode.

### CROSS-REFERENCE TO RELATED APPLICATIONS

This is a 371 application from international patent application PCT/IB2024/050043 filed Jan. 3, 2024, titled SYSTEM AND METHOD FOR WIRELESS POWER FACTOR CORRECTED AC POWER DELIVERY WITHOUT AN ACTIVE GRID-SIDE CONVERTER and is related to and claims priority from U.S. Provisional Patent Application 63/436,696 filed Jan. 3, 2023 is incorporated herein by reference in its entirety.

### FIELD

Embodiments disclosed herein relate generally to systems and methods for wireless power transfer.

### BACKGROUND

Wireless power transfer systems utilizing an electro-magnetic field as a means of power transfer have been shown as advantageous in comparison to use of wired transfer system as a means of power transfer, providing electrical and mechanical isolation, safety of operation in different environments, and ease of use by consumers. These advantages have driven an increasing interest in wireless power transfer technology in low power applications such implantable biomedical devices which would otherwise be unreachable for purpose of charging and also high-power applications such as electrical vehicle (EV) charging.

The description above is presented as a general overview of related art in this field and should not be construed as an admission that any of the information it contains constitutes prior art against the present patent application.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale.

FIG. 1A shows a typical wired universal input AC/DC power conversion system with a power factor correction rectifier (PFCR).

FIG. 1B shows a control scheme of an off-the-shelf PFCR.

FIG. 1C shows an equivalent circuit for the systems shown in FIGS. 1A and 1B.

FIGS. 2A-2B are circuit block diagrams of an inductive wireless power transfer system with standard source side PFCR.

FIGS. 3A and 3B show an alternative inductive wireless power transfer system with output side power factor correction (PFC).

FIG. 4A is a circuit block diagram of an inductive wireless power transfer system according to some embodiments.

FIG. 4B is a circuit block diagram of an inductive wireless power transfer system according to some alternative embodiments.

FIG. 4C is a circuit block diagram of an inductive wireless power transfer system according to some other embodiments.

FIG. 4D is an equivalent circuit diagram of an operational low frequency system 400 according to some embodiments, with the gyrator of FIG. 3B replaced by an ideal transformer.

FIG. 5 is a circuit block diagram of an inductive wireless power transfer system, according to some embodiments.

FIG. 6 is a circuit block diagram of a three-phase wireless power transfer system, according to some embodiments.

FIG. 7 is an exemplary circuit used to demonstrate the efficacy of the disclosed systems according to some implementations.

FIGS. 8A-8E show experimental current and voltage waveforms illustrating the efficacy of the disclosed systems, according to some embodiments.

### DETAILED DESCRIPTION

Transmitters of practical inductive wireless power transfer (IWPT) systems may be powered by DC voltage obtained at the output of grid-interfacing power factor correction (PFC) rectifiers (PFCR). On the load side, load interfacing DC-DC converters may often be utilized to regulate IWPT system output under load and coupling variations, thus duplicating the DC-DC converters in such a system. In addition, IWPT systems may employ wireless communication-based feedback between the supply and load sides, adding to the overall system complexity.

An IWPT link (IWPTL) may include two loosely coupled coils operating as an air-core loosely coupled transformer (LCT) transferring power from a primary to a secondary coil via an alternating magnetic field. The absence of a magnetic core limits the power transfer capability of a standalone LCT. Operating an IWPT close to resonance with the addition of a compensation network is a widely utilized solution and there are many topologies of varying complexity.

IWPT system output characteristics are highly dependent on the coupling coefficient k between primary and secondary coils. This coefficient is in turn dependent on the geometrical positioning between the two coils, which may vary in practical applications, i.e., EV charging where vertical and horizontal distance between static charger coil and vehicle coil may differ as a result of inexact parking or varying vehicle clearance to ground. This creates the need for robust systems which can operate for a range of coupling coefficients rather than a single value.

Another common problem in the field of WPT may arise when primary side electronics are used to control system output creating the need for wireless feedback from the secondary side. The speed of such communication may be slow resulting from high latency and may increase overall system complexity.

Furthermore, when powering IWPT systems from grid, power factor correction must be considered in order to comply with industry standards and may generally be achieved by adding a PFCR unit between the grid and the IWPTL. These PFCR units may employ current shaping in order to draw a sinusoidal current that is substantially in phase with the grid voltage sinusoid.

Some proposed IWPTL solutions operate in load-independent current output (LICO) mode with power factor correction on the supply side and high coupling variation tolerance, without the need for wireless feedback achieved by using a load side DC-DC converter with voltage shaping control. Since such systems require voltage shaping (in contrast to current shaping of an off-the-shelf PFCR) specific application-oriented hardware must be designed/provided.

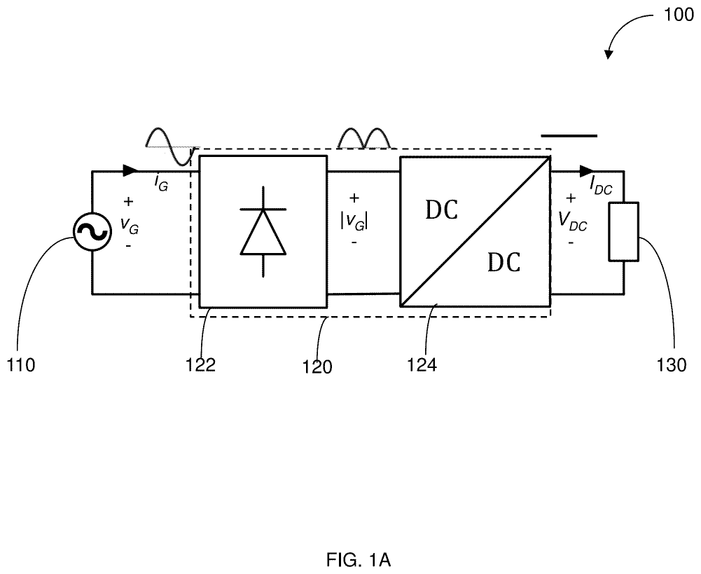

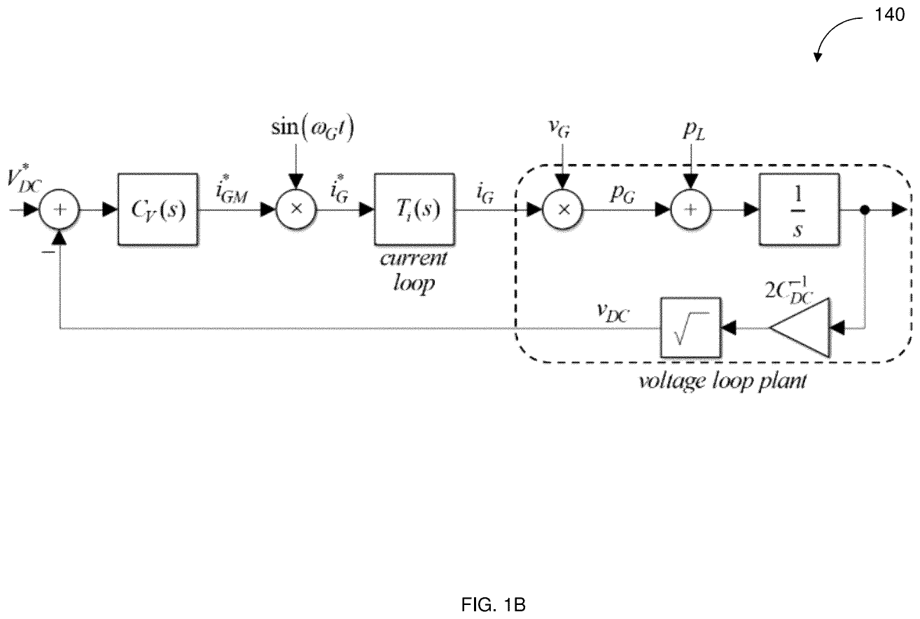

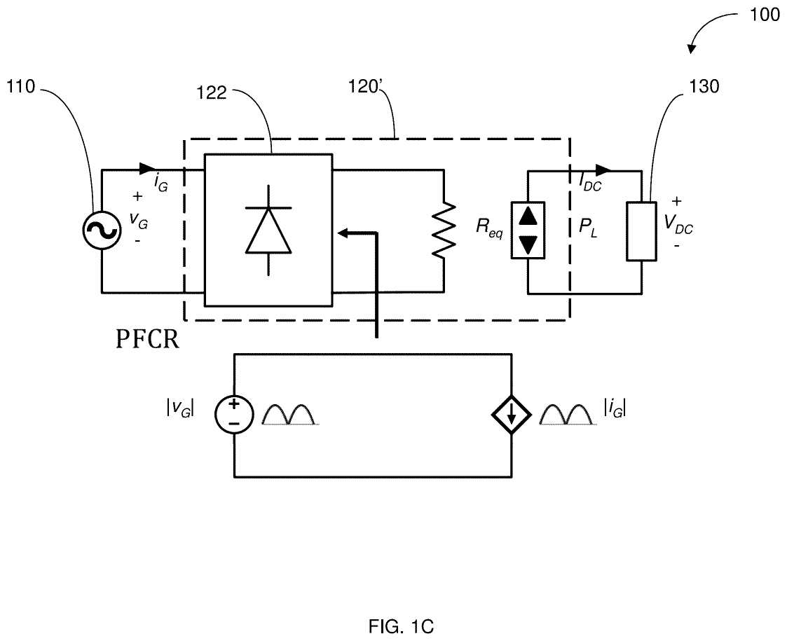

FIG. 1A shows a typical wired universal input (95 VRMS-264 VRMS, 50/60 Hz) AC/DC power conversion system 100 fed by a grid 110 with a grid fed power factor correction rectifier (PFCR) 120 consisting of full bridge rectifier 122 and load-interfacing, current shaping DC/DC converter 124 connected to a load 130. Grid voltage and current are indicated by v_{G} and i_{G} with output voltage and current given as V_{DC}, I_{DC}, respectively.

FIG. 1B shows a control scheme 140 of an off-the-shelf PFCR 120 with a voltage compensator Cᵥ(s) (typically a PI controller). Tᵢ(s)≈1 is assumed, since current loop bandwidth is typically much higher than grid frequency. It is assumed that grid voltage is sinusoidal and that PFCR 120 draws a sinusoidal current in phase with main voltage (see equation below)

$${v}_{G} ( t ) = {V}_{G} sin ( {ω}_{G} t ) , {i}_{G} ( t ) = {I}_{G} sin ( {ω}_{G} t ) , \qquad ( 1 )$$

for grid frequency of ω_{G}.

Load power, grid power and DC link capacitance are symbolized by P_{L}, P_{G} and C_{DC} respectively with reference DC voltage given by V*_{DC}.

FIG. 1C shows an equivalent circuit for the systems shown in FIGS. 1A and 1B. FIG. 1C shows a low frequency (grid frequency) “averaged” circuit that models PFCR 120 operation from the viewpoint of a source and load at grid frequency.

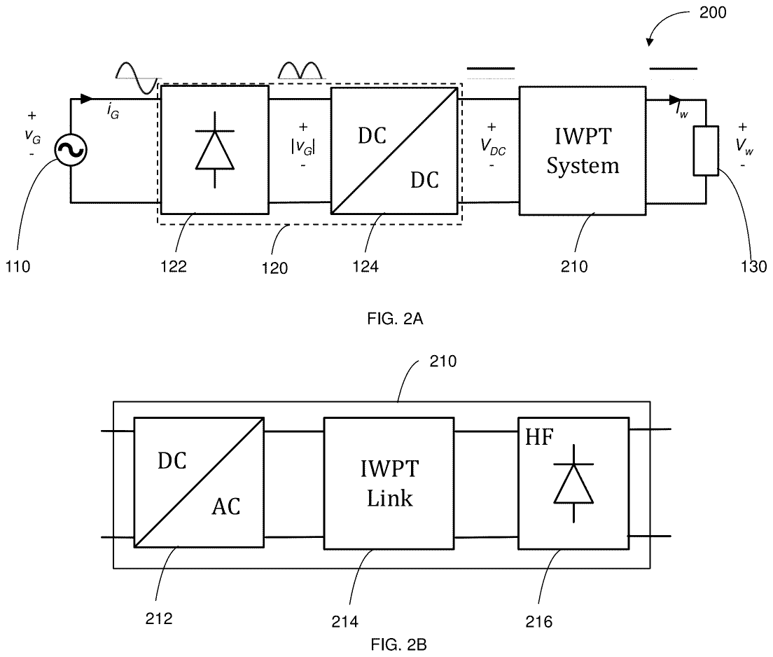

FIGS. 2A-2B are circuit block diagrams of an inductive wireless power transfer system with a standard source side PFCR. FIGS. 2A and 2B show an IWPT system 200. As shown in FIG. 2A, an IWPT system 210 is integrated into system 100 of FIG. 1A for delivery of wireless power to load 130. IWPT system 210 is typically required to be fed by a DC voltage source, and PFCR 120 may be utilized in order to provide such a source and interface the system to grid 110 while performing power factor correction. FIG. 2B is a block diagram of a typical IWPT system 210 consisting of a high frequency inverter 212, compensated IWPTL 214 and high frequency load side rectifier 216.

Operating an IWPTL 214 in resonance may achieve load independent voltage output (LIVO) or LICO. The output may then be dependent on the IWPT inverter 212 input voltage and may be directly or inversely (depending on the compensation topology) proportionate to a coupling coefficient k. Depending on the choice of compensation topology, the compensation network passive component values may be dependent on the coupling coefficient (i.e., LIVO series-series compensation). There are also topologies where compensation component values may be independent of k such as LCC-S operating in LIVO mode. For these topologies, varying coupling coefficient only affects system output, and a common solution utilizes wireless feedback from the load side and input voltage control where a supplementary DC/DC converter is added between PFCR 120 and IWPT system 210 to keep the output stable for different values of k by changing the input voltage.

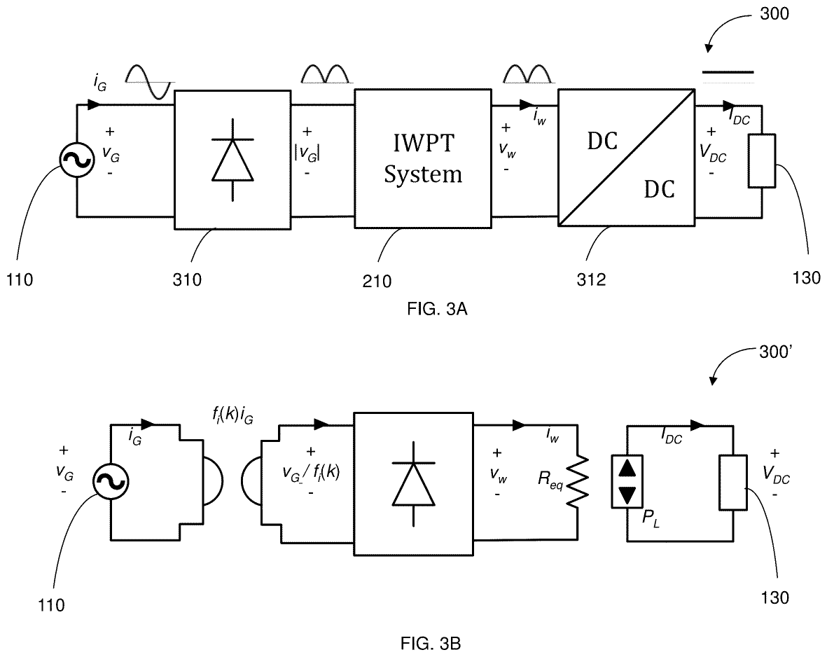

FIGS. 3A and 3B show an alternative IWPT system 300 such as proposed by Avila et al (A. Avila, A. Garcia-Bediaga, U. Iruretagoyen, I. Villar and A. Rujas, “Comparative evaluation of front and back-end PFC IPT systems for a contactless battery charger,” in Proc. IEEE Energy Conv. Cong. Expo. (ECCE), Cincinnati, Ohio, USA, 2017, pp. 118-125). FIG. 3A is a block diagram of system 300 and FIG. 3B shows an equivalent circuit 300′. System 300 operates in LICO mode and may be fed from grid 110 via a simple rectifier 310 with a PFCR omitted. The system's output current is then given by:

$${i}_{w} ( t ) = {f}_{i} ( k ) {V}_{G} \vert sin ( {ω}_{G} t + ϕ ) \vert \qquad ( 2 )$$

where fᵢ(k) is the coupling coefficient dependent constant gain between the IWPT system inverter input voltage and σ is the phase difference between iₒ and v_{G}. A load interfacing DC/DC converter 312 may be utilized to shape the IWPT system output voltage as:

$${v}_{w} ( t ) = {R}_{e q} {i}_{w} ( t ) , {R}_{e q} = \frac{2 {P}_{L d}}{{{f}_{i} ( k )}^{2} {V}_{G}} , \qquad ( 3 )$$

for desired load power P_{Ld}. It was demonstrated by Avila et al that such operation achieves grid unity power factor and allows control of power delivered to the load. According to equation (2), FIG. 3A may be represented by the operational block diagram in FIG. 3B where the grid side rectifier 310 and IWPT system 210 are modelled by a rectifier followed by a gyrator with gyration resistance fᵢ(k).

In system 300, DC/DC converter 312 is utilized for voltage shaping in contrast to the current shaping control shown in FIG. 1B such that off-the-shelf PFCR units cannot be utilized and specialized additional components must be designed/provided thus increasing system cost and complexity.

Generally, embodiments of the present invention pertain to a topology where the load, and not the supply (e.g., grid-side), employs a PFCR. In other words, the supply may be PFCR-free. The performance outputs of the load-side PFCR may be identical or substantially identical to the topologies where the PFCR is on the supply-side.

It is noted that although PFCRs discussed in conjunction with the accompanying figures are shown as being implemented by a rectifier-DC/DC converter topology, this should by no means be construed in a limiting manner. Accordingly, any of the embodiments of the invention discussed and claimed herein may employ alternative PFCR topologies including, for example, bridgeless topology, and totem pole topology. In some examples, the rectifier of the rectifier-DC/DC PFCR topology (also: PFCR rectifier) is a low-frequency (LF) power correction rectifier. As will be outlined in further detail below, the PFCR rectifier may be connected in series with the DC/DC and a preceding electronic component (e.g., HF rectifier), or in parallel. In the parallel configuration, the PFCR rectifier and the DC/DC may be connected in parallel to a preceding component (e.g., HF rectifier and/or a bypass capacitor). An HF rectifier and/or a bypass capacitator may also be employed in alternative PFCR topologies and, optionally, analogously configured (e.g., in a parallel or in a series configuration) as in the rectifier-DC/DC PFCR topology, as may be required.

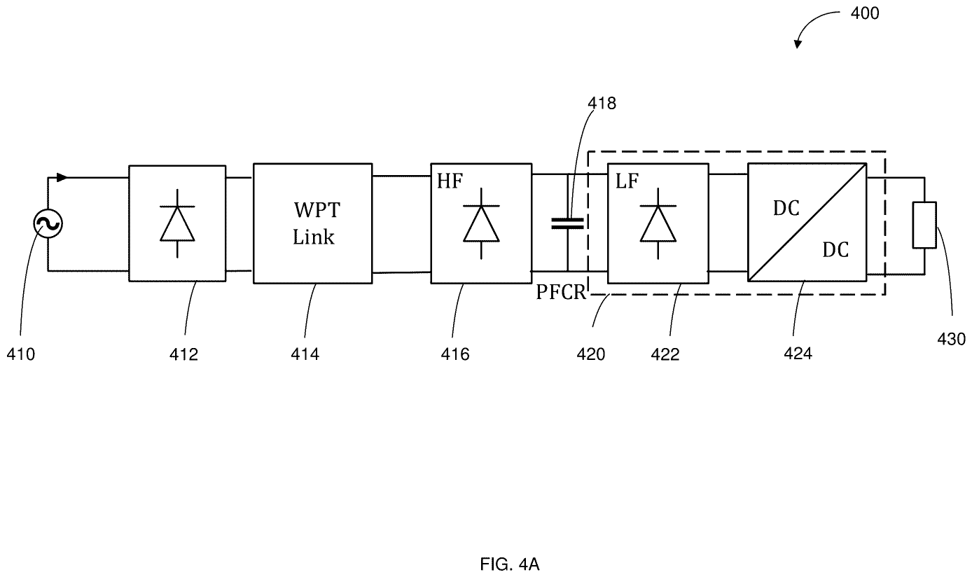

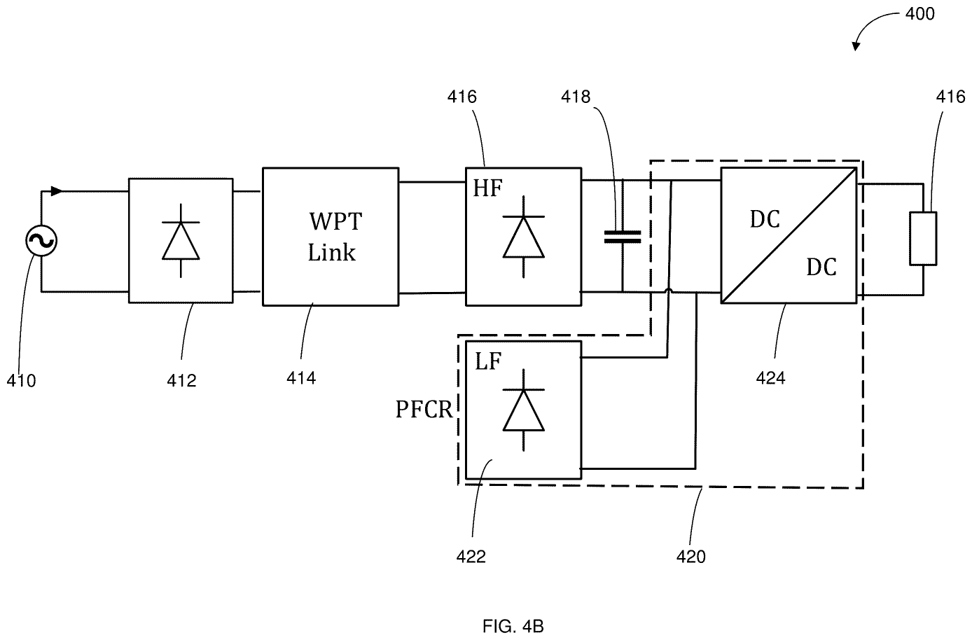

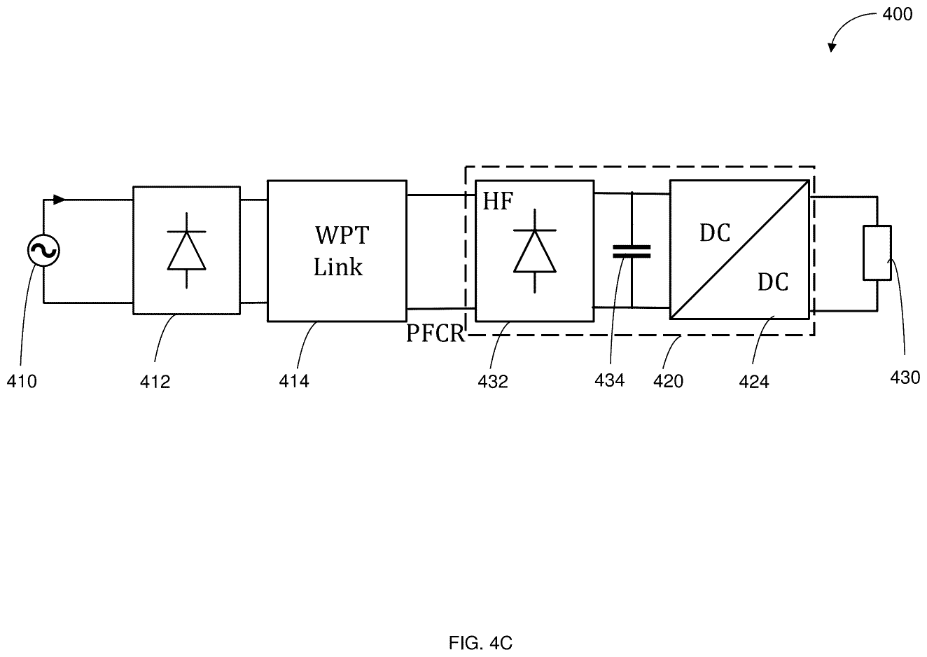

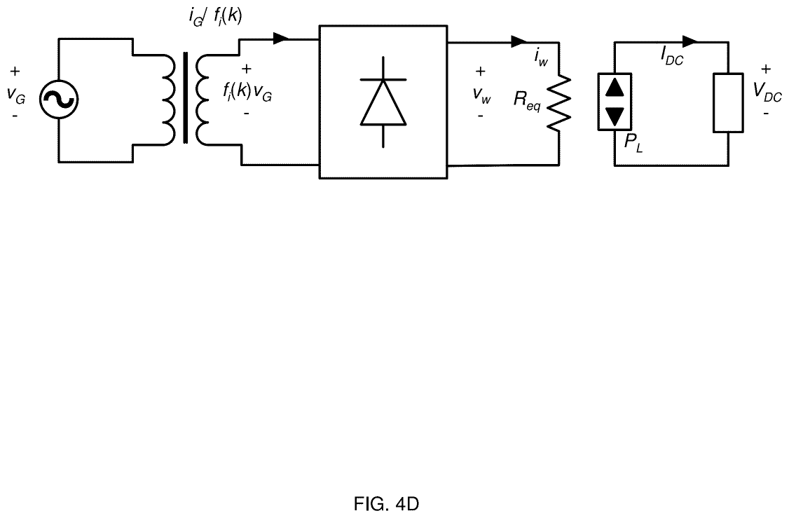

FIGS. 4A-4D are circuit block diagrams of an IWPT system 400, according to some embodiments. IWPT system 400 may include a grid supply 410, rectifier 412, Wireless Power Transfer Link (WPTL) 414, high frequency rectifier 416, high frequency bypass capacitor 418, PFCR 420 including a low frequency rectifier (e.g., 50 Hz/60 Hz) 422, and a current shaping DC/DC converter 424, connected to a load 430. In some embodiments, WPTL 414 may include a DC/AC converter, primary and secondary coils and, in some examples, primary and secondary compensation networks (not shown).

In a non-limiting example, a high frequency component (416, 418) may operate at a frequency of, for example, 85 kHz such as for EV charging.

In known systems, a comparatively large capacitor is used to stabilize a constant DC voltage while in regular use case. In the embodiments discussed capacitor 418 is configured to output waveforms similar to rectified grid, i.e., to follow a certain waveform.

IWPT system 400 may attain a substantially unity power factor operation on the grid-side as well as IWPT system output regulation without the need for wireless feedback and/or a grid-side PFCR. In some embodiments, the disclosed IWPT system 400 may operate in load-independent voltage output (LIVO) mode reducing overall system complexity.

In some embodiments, an (e.g., off-the-shelf) load interfacing converter 424 may perform both output regulation and power factor correction (with current shaping operation), further reducing overall system complexity. In cases where the load is purely resistive, power factor conversion can be obtained without employing a DC/DC block.

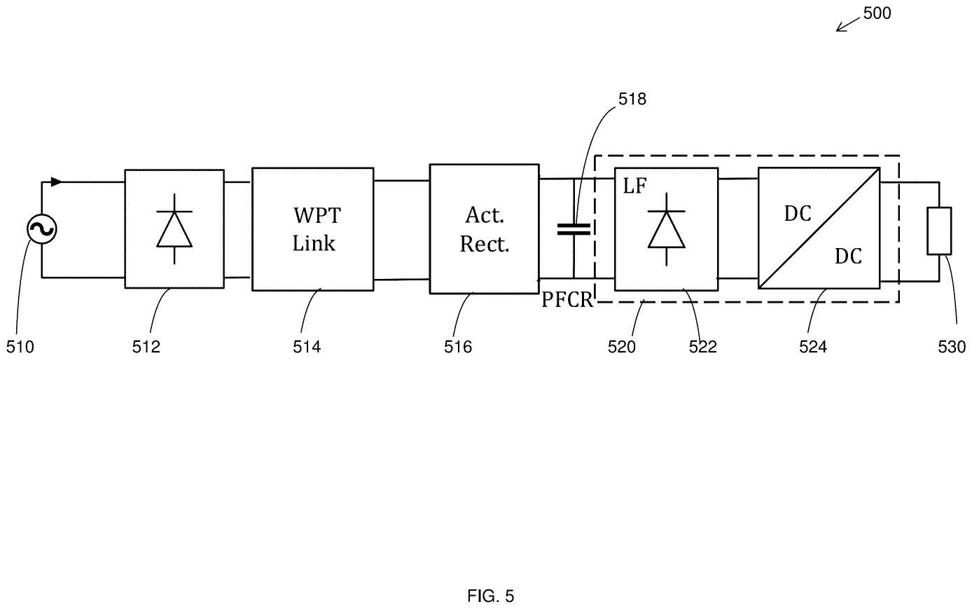

In some alternative embodiments (FIG. 5), a LICO mode may be used. It is anticipated that disclosed embodiments may significantly reduce IWPT system costs and complexity.

With system 400 operating in LIVO mode, the output voltage is given by:

$${v}_{w} = {f}_{v} ( k ) {V}_{G} \vert sin ( {ω}_{G} t + ϕ ) \vert , \qquad ( 4 )$$

Load side DC/DC converter 424 may be utilized to shape the current

$${i}_{w} = \frac{{v}_{w}}{{R}_{e q}} , {R}_{e q} = \frac{{{f}_{v} ( k )}^{2} {V}_{G}^{2}}{2 {P}_{L d}} . \qquad ( 5 )$$

In some embodiments, since off-the-shelf PFCR 420 mostly utilizes low frequency rectifier 422 operating at, e.g., 50 Hz/60 Hz, while WPTL 414 operates at a comparatively high frequency, high frequency rectifier 416 may be required as PFCR 420 may not be connected directly to WPTL 414 and must be interfaced via high frequency rectifier 416, resulting in at least two configurations as shown in FIG. 4A and FIG. 4B.

In some embodiments, such as shown in FIG. 4A, PFCR 420 may be connected directly in series high frequency rectifier 416 with an added high frequency bypass capacitor 418 C_{b}. In this solution, rated power flows constantly through both rectifiers (the same two low frequency diodes conduct constantly), which may negatively impact system efficiency.

In some embodiments, such as shown in FIG. 4B, the configuration bypasses low frequency rectifier 422, connecting current shaping DC/DC converter 424 to high frequency rectifier 416 output (via capacitor 418). The LF rectifier 422 is connected in parallel to the DC/DC converter 424 and the HF rectifier 416, e.g., via the HF capacitor 418. The added complexity (compared to the system of FIG. 4A) of bypassing rectifier 422 is offset by improving full system efficiency in comparison to the configuration of FIG. 4A.

In some embodiments, such as shown in FIG. 4C, if PFCR 420 includes a high frequency rectifier 432 (and optional capacitor 434), low frequency rectifier 422 may be omitted.

FIG. 4D is an equivalent circuit diagram of an operational low frequency system 400 according to some embodiments, with the gyrator of FIG. 3B replaced by an ideal transformer having a coupling coefficient dependent winding ratio fᵥ(k). FIG. 5 is a circuit block diagram of an IWPT system 500 according to some disclosed embodiments. In some embodiments, WPT system 500 may include a grid supply 510, rectifier 512, WPTL 514, active rectifier 516, high frequency bypass capacitor 518, PFCR 520 including a low frequency rectifier (50 Hz/60 Hz) 522 and a current shaping DC/DC converter 524, connected to a load 530. In some embodiments, WPTL 514 may include a DC/AC converter, primary and secondary coils, and primary and secondary compensation networks (not shown).

As described above, in some implementations, the output voltage of a WPT system is dependent on the coupling coefficient between the WPT coils, which may be inconvenient in some applications. Therefore, in some embodiments, such as shown in FIG. 5, a LICO system may be utilized with active rectifier 516 connected at the output of WPTL 514. An output voltage negative feedback loop may then be utilized alongside active rectifier 516 in order to attain an output voltage following a reference voltage of:

$${v}_{w} = {v}_{ref} = {mV}_{G} \vert sin ( {ω}_{G} t ) \vert , \qquad ( 6 )$$

for a certain gain m that can be kept independent on coupling between WPTL 514 coils. Considering that the reference voltage is kept in phase with the grid voltage and DC/DC converter 524 is used to shape current according to:

$${i}_{w} = \frac{{v}_{w}}{{R}_{e q}} = \frac{{mV}_{G}}{{R}_{e q}} \vert sin ( {ω}_{G} t ) \vert , \qquad ( 7 )$$

### Then the Resulting Power May be Given as Function of Time as:

$${P}_{o} = \frac{{m}^{2} {V}_{G}^{2}}{{R}_{eq}} {sin}^{2} ( {ω}_{G} t ) . \qquad ( 8 )$$

Examining equation (8) alongside equation (1) and assuming a system efficiency of 100% for simplicity yields grid current:

$${i}_{g} = \frac{{P}_{o}}{{v}_{G}} = \frac{{m}^{2} {V}_{G}}{{R}_{eq}} sin ( {ω}_{G} t ) , \qquad ( 9 )$$

which is a sinusoid of identical frequency and phase to the grid voltage, resulting in a unity power factor and demonstrating successful power factor correction attained by a load-side off-the-shelf PFCR 520.

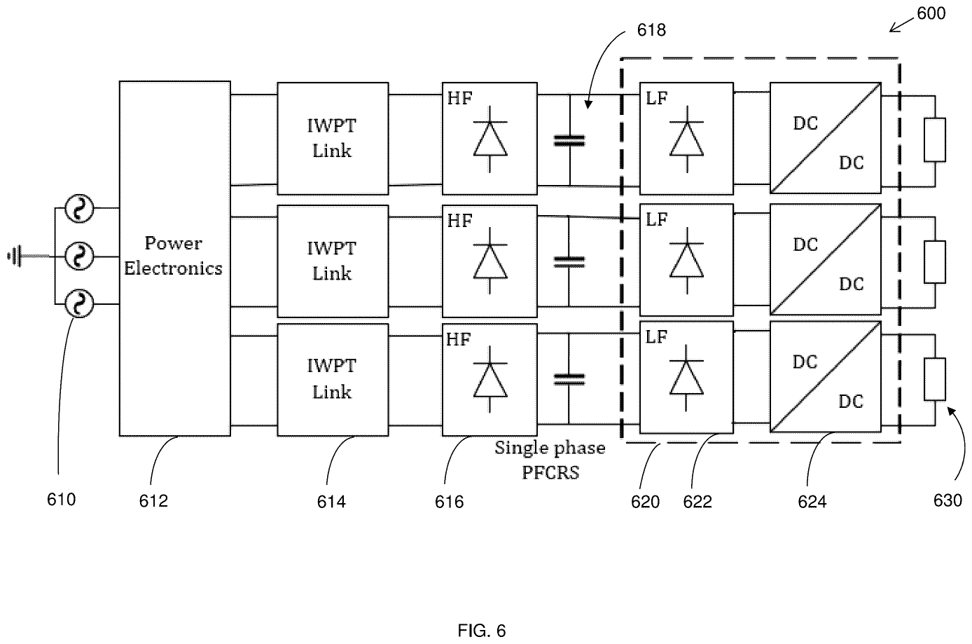

FIG. 6 is a circuit block diagram of a three-phase WPT system 600 according to some disclosed embodiments. In some embodiments, three-phase WPT system 600 may include a grid supply 610, three-phase power electronics 612, WPTLs 614, HF rectifiers 616, high frequency bypass capacitors 618, PFCRs 620 each including a low frequency rectifier (50 Hz/60 Hz) 622 and a current shaping DC/DC converter 624, connected to three-phase load 630. As shown, components 614, 616, 618, and 620 are duplicated. In some embodiments, WPTLs 614 may include a DC/AC converter, primary and secondary coils, and primary and secondary compensation networks (not shown).

In some embodiments, the systems 400 and 500 described above, being entirely modular, may be duplicated such that three separate symmetrical systems may each be fed by a separate grid phase (vₐ, v_{b}, v_{c}), producing output voltages v_{wa}, v_{wb}, v_{wc} given by:

$${v}_{w a} = {f}_{v} ( k ) {V}_{G} \vert sin ( {ω}_{G} t + ϕ ) \vert , \qquad ( 10 )$$

$${v}_{w b} = {f}_{v} ( k ) {V}_{G} \vert sin ( {ω}_{G} t + ϕ + {120}^{o} ) \vert , {v}_{w b} = {f}_{v} ( k ) {V}_{G} \vert sin ( {ω}_{G} t + ϕ + {240}^{o} ) \vert$$

### For Grid Phase Voltages of:

$${v}_{a} = {V}_{G} sin ( {ω}_{G} t ) , {v}_{b} = {V}_{G} sin ( {ω}_{G} t + 12 {0}^{o} ) , {v}_{c} = {V}_{G} sin ( {ω}_{G} t + 24 {0}^{o} ) . \qquad ( 11 )$$

The system output voltages calculated according to equation (10) may then be utilized to feed three separate off-the-shelf single phase PFC rectifiers 620 delivering power to load 630. In some embodiments, WPTLs 614 may integrate with a three-phase PFC rectifier unit (not shown). The separate PFCR 620 case is shown in FIG. 6 where a generalized power electronics 612 interfaces between a 3-phase grid 610 and three separate symmetrical WPTL 614 systems. It should be appreciated that the embodiment of FIG. 5 may also be modularly expanded to a three-phase system similarly to the configuration shown in FIG. 6.

### Example

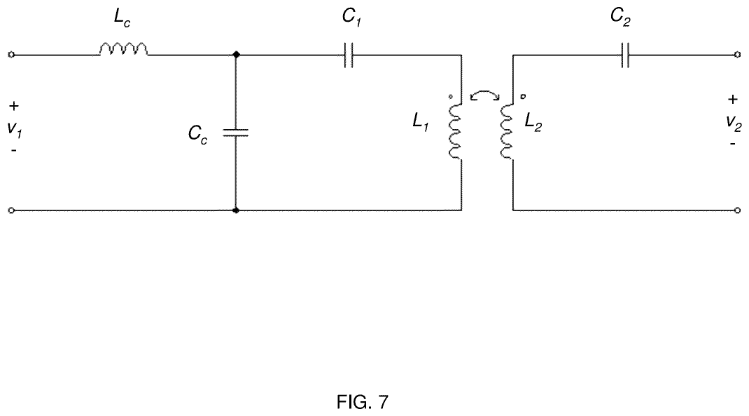

Passive component values of a WPT topology operating in LIVO mode are independent of coupling coefficient. An exemplary circuit is shown in FIG. 7 and was chosen in order to demonstrate the operation of the disclosed systems such as system 400. An input high frequency inverter output voltage is denoted by v₁, and secondary side output voltage (rectifier input voltage) is given as v₂. LIVO operation is achieved when the compensation network passive component values (independent of coupling coefficient) uphold:

$${ω}_{0} = \sqrt{{L}_{c} {C}_{c}} = \sqrt{( {L}_{1} - {L}_{c} ) {C}_{1}} = \sqrt{{L}_{2} {C}_{2}} . \qquad ( 12 )$$

The WPT System Voltage Gain fᵥ(k) is then Given by:

$${f}_{v} ( k ) = \frac{k \sqrt{{L}_{1} {L}_{2}}}{{L}_{c}} . \qquad ( 13 )$$

The circuit shown in FIG. 7 was constructed in PSIM software (LCC-S compensated IWPTL) with full circuit parameters summed up in Table 1. It should be noted that the system is fed by a 230 VRMS, 50 Hz grid with a 400V EV battery serving as the system load. The DC/DC converter utilized is a boost converter meaning that for correct operation the following must be true

$${f}_{v} ( k ) {∇}_{G} < 400 \to k < \frac{400}{{V}_{G}} \frac{{L}_{c}}{\sqrt{{L}_{1} {L}_{2}}} , \qquad ( 14 )$$

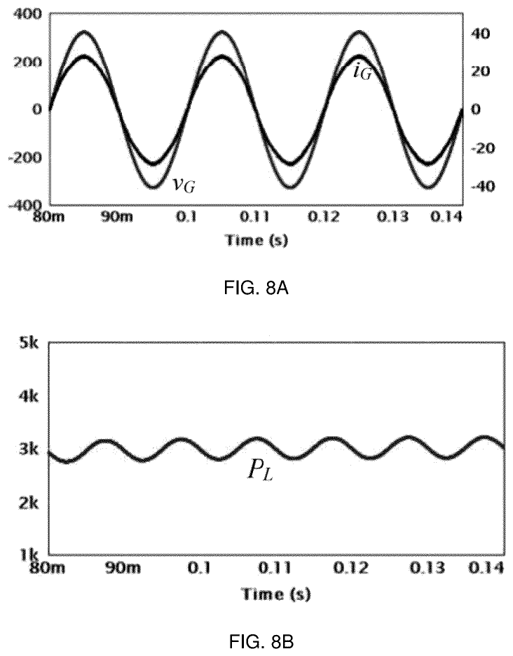

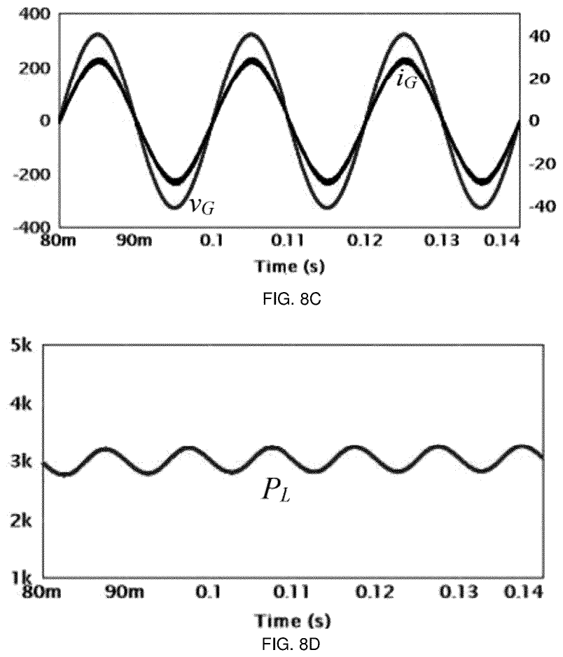

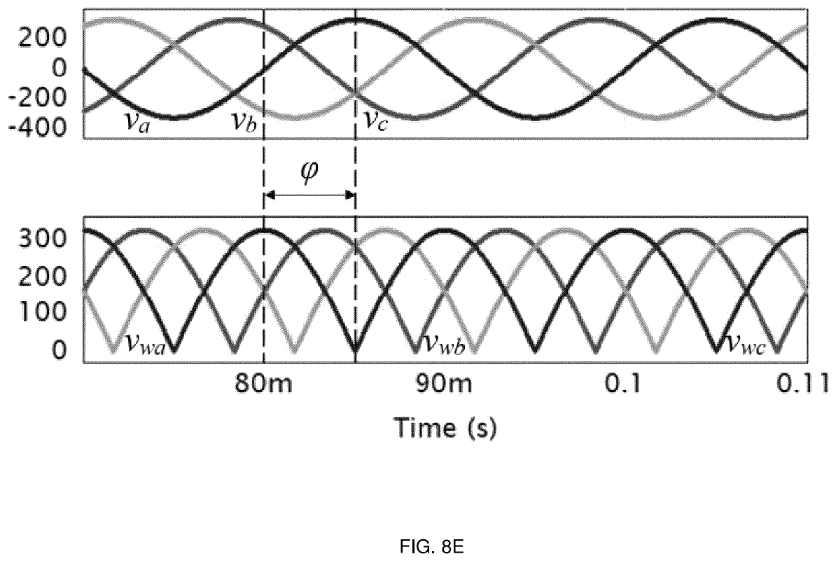

allowing the example system to operate correctly for k<0.36. Taking this into consideration, the system was simulated for a range of coupling coefficients in order to demonstrate that desired output power can be kept at 3 kW for different operational points. FIG. 8A shows grid voltage and current waveforms alongside power delivered to battery load in FIG. 8B for k=0.3. Similar waveforms are demonstrated in FIG. 8C and FIG. 8D for k=0.15.

TABLE 1
System parameter values

| Parameter | Value | Units |
|---|---|---|
| V_{G} | 230 | VRMS |
| V_{bat} | 400 | V |
| P_{Ld} | 3000 | W |
| L₁, L₂ | 170 | μH |
| L_{c} | 50 | μH |
| C₁ | 29.2 | nF |
| C₂ | 20.6 | nF |
| C_{c} | 70 | nF |
| ω | 2 · π · 85 | krad/s |

Observing grid waveforms of both cases it is evident that the current is sinusoidal and in phase with the mains voltage resulting in a power factor of 0.999 for both k=0.3 and k=0.15. Furthermore, observing output waveforms in the two cases makes it clear that the desired power is delivered to load for both values of k. The simulated results are in line with analytical expectation as power factor close to unity was achieved and output power was kept constant for varying coupling coefficient while utilizing current shaping control of off-the-shelf PFC DC/DC converter with low side voltage limited to the 80 VRMS-250 VRMS range. Control of output power is performed on the load side only, removing the need for wireless feedback.

An example of grid and v_{wa}, v_{wb}, v_{wc} waveforms for a case where f (k)=1 (such as for system 600) is presented in FIG. 8E.

### Additional Examples

Example 1 Pertains to a Wireless Power Transfer (WPT) System Comprising:
a wireless power transfer link (WPTL); and
on a load-side of the WPTL, a high frequency (HF) rectifier positioned between the WPTL and a load, wherein the load includes a power factor correction rectifier (PFCR).

Example 2 includes the subject matter of example 1 and, optionally, wherein the PFCR is implemented with one of the following non-limiting example circuitry topologies: bridgeless topology, totem pole topology, and a rectifier-DC/DC topology.

Example 3 includes the subject matter of Example 1 and/or Example 2 and, optionally, wherein the high frequency rectifier is connected in series to the input of the PFCR via an HF bypass capacitor.

Example 4 includes the subject matter of Example 2 and, optionally, wherein the high frequency rectifier is connected in series to the LF power factor correction rectifier via an HF bypass capacitor, or in series to another electronic component of an alternative PFCR topology.

Example 5 includes the subject matter of any one or more of the Examples 2 to 4, optionally, wherein the high frequency rectifier is connected in series to the current shaping DC/DC converter via an HF bypass capacitor. In some examples, the LF power factor correction rectifier is connected in parallel with the current shaping DC/DC converter, or in parallel to an electronic of an alternative PFCR topology.

Example 6 includes the subject matter of any one or more of the Examples 1 to 5 and, optionally, wherein the WPTL is operated in load independent voltage output (LIVO) mode.

Example 7 includes the subject matter of any one or more of the Examples 1 to 6 and, optionally, on a supply-side of the WPTL, an AC power supply, wherein the AC power supply and supply-side of the WPTL are connected without power factor correction circuitry.

Example 8 includes the subject matter of any one or more of the Examples 1 to 7 and, optionally, wherein the WPTL includes a DC/AC converter and primary and secondary coils.

Example 9 includes the subject matter of any one or more of the Examples 1 to 8, and, optionally, wherein the PFCR is an off-the-shelve PFCR.

Example 10 pertains to a wireless power transfer (WPT) system comprising:
a wireless power transfer link (WPTL) positioned between a supply and a load; and
wherein the load includes an HF rectifier connected in series to a current shaping DC/DC converter via an HF bypass capacitor.

Example 11 includes the subject matter of Example 10 and, optionally, wherein the WPTL is operated in load independent voltage output (LIVO) mode.

Example 12 includes the subject matter of any one or more of the Examples 10 to 11 and, optionally, on a supply-side of the WPTL, an AC power supply, wherein the AC power supply and supply-side of the WPTL are connected without power factor correction circuitry.

Example 13 includes the subject matter of any one or more of the Examples 10 to 12 and, optionally, wherein the WPTL includes a DC/AC converter and primary and secondary coils.

Example 14 pertains to a wireless power transfer (WPT) system comprising:
a wireless power transfer link (WPTL) operating in load independent current output (LICO) mode;
on a load-side of the WPTL, an active rectifier positioned between the WPTL and a load, wherein the load includes a power factor correction rectifier (PFCR).

Example 15 includes the subject matter of Example 14 and, optionally, wherein the PFCR is implemented by one of the following selected topologies: a low frequency (LF) rectifier and a current shaping DC/DC converter connected to the output of the LF rectifier; a bridgeless topology, and a totem pole topology.

Example 16 includes the subject matter of Example 14 and/or Example 15 and, optionally, wherein the PFCR is an off-the-shelve PFCR.

Example 17 includes the subject matter of Example 14 and/or Example 16 and, optionally, wherein the active rectifier is connected in parallel or in series to the LF rectifier, or to an electronic component of an alternative PFCR circuitry topology.

Example 18 includes the subject matter of any one or more of the examples 15 to 17 and, optionally, wherein the active rectifier is connected in series to the LF power factor correction rectifier via an HF bypass capacitor, or in series to an electronic component of an alternative PFCR topology.

Example 19 includes the subject matter of any one or more of the examples 14 to 18 and, optionally, further including, on a supply-side of the WPTL, an AC power supply, wherein the AC power supply and supply-side of the WPTL are connected without power factor correction circuitry.

Example 20 includes the subject matter of any one or more of the examples 14 to 19 and, optionally, wherein the WPTL includes a DC/AC converter and primary and secondary coils.

Example 21 pertains to a three-phase wireless power transfer (WPT) system comprising:
a wireless power transfer link (WPTL) for each phase; and
on a load-side of the WPTL for each phase, a high frequency (HF) rectifier positioned between the WPTL and a three-phase load, wherein each phase of the three-phase load includes a power factor correction rectifier (PFCR).

Example 22 includes the subject matter of example 21 and, optionally, wherein the PFCR comprises one of the following non-limiting example topologies: a rectifier-DC/DC topology; a bridgeless topology; a totem pole topology.

Example 23 includes the subject matter of any one or more of the examples 21 to 22 and, optionally, wherein the PFCRs employed are off-the-shelve PFCRs.

Example 24 includes the subject matter of any one or more of the Examples 21 to 23 and, optionally, wherein in each phase, the high frequency rectifier is connected in series to the input of the PFCR via an HF bypass capacitor.

Example 25 includes the subject matter of example 21 and, optionally, wherein the rectifier of the rectifier-DC/DC topology is a low-frequency (LF) power correction rectifier.

Example 26 includes the subject matter of any one or more of the Examples 21 to 25 and, optionally, wherein in each phase, the high frequency rectifier is connected in series to the rectifier via an HF bypass capacitor.

Example 27 includes the subject matter of any one or more of the Examples 21 to 26 and, optionally, wherein the rectifier is connected in parallel with the current shaping DC/DC converter.

Example 28 includes the subject matter of any one or more of the examples 21 to 27 and, optionally, wherein the WPTL in each phase is operated in load independent voltage output (LIVO) mode.

Example 29 includes the subject matter of any one or more of the examples 21 to 28 and, optionally, further including, on a supply-side of the WPTL in each phase, a three-phase AC power supply, wherein the three-phase AC power supply and supply-side of the WPTL are connected without power factor correction circuitry.

Example 30 includes the subject matter of any one or more of the examples 21 to 29 and, optionally, wherein the WPTL includes a DC/AC converter and primary and secondary coils.

Example 31 pertains to a method for implementing a wireless power transfer (WPT), the method comprising:
providing a wireless power transfer link (WPTL); and
providing, on a load-side of the WPTL, a high frequency (HF) rectifier positioned between the WPTL and a load,
wherein the load-side includes a power factor correction rectifier (PFCR).

Example 32 includes the subject matter of example 31 and, optionally, wherein PFCRs employed for each phase are off-the-shelve PFCRs.

Example 33 includes the subject matter of example 31 and/or example 32 and, optionally, wherein the PFCR is selected from one of the following topologies:
low frequency (LF) rectifier and a current shaping DC/DC converter connected to the output of the LF rectifier;
a bridgeless topology, and
a totem pole topology.

Example 34 includes the subject matter of example 33 and, optionally, wherein the high frequency rectifier is connected in series to the LF power factor correction rectifier via an HF bypass capacitor.

Example 35 includes the subject matter of example 33 and/or example 34 and, optionally, wherein the high frequency rectifier is connected in series to the current shaping DC/DC converter via an HF bypass capacitor, and wherein, for example, the LF power factor correction rectifier is connected in parallel or in series with the current shaping DC/DC converter and the HF bypass capacitor.

Example 36 includes the subject matter of any one or more of the Examples 31 to 35 and, optionally, wherein the WPTL is operated in load independent voltage output (LIVO) mode.

Example 37 includes the subject matter of any one or more of the Examples 31 to 36 and, optionally, providing, on a supply-side of the WPTL, an AC power supply, wherein the AC power supply and supply-side of the WPTL are connected without power factor correction circuitry.

Example 38 pertains to a method for implementing a wireless power transfer (WPT) system, the method comprising:
providing a wireless power transfer link (WPTL) positioned between a supply and a load, wherein the load includes an HF rectifier connected in series to a current shaping DC/DC converter via an HF bypass capacitor.

Example 39 pertains to a method for implementing a wireless power transfer (WPT) system, the method comprising:
providing a wireless power transfer link (WPTL) operating in load independent current output (LICO) mode;
providing, on a load-side of the WPTL, an active rectifier positioned between the WPTL and a load,
wherein the load includes a power factor correction rectifier (PFCR).

Example 40 includes the subject matter of Example 39 and, optionally, wherein PFCR is implemented using one of the following circuitry topologies: a rectifier-DC/DC converter topology; a bridgeless topology; and a totem pole topology.

Example 41 includes the subject matter of example 40 and, optionally, wherein the rectifier is a low-frequency rectifier, and the DC/DC converter is a current shaping DC/DC converter.

Example 42 includes the subject matter of any one more of the Examples 39 to 41 and, optionally, wherein the PFCR is an off-the-shelve PFCR.

Example 43 includes the subject matter of any one or more of the examples 39 to 42 and, optionally, wherein the active rectifier is connected in parallel or in series to the LF rectifier.

Example 44 pertains to a method for implementing a wireless power transfer (WPT) between an AC supply and a load, the method comprising:
transferring power wirelessly using an inductive wireless power transfer link (WPTL) positioned between the AC supply and the load; and
rectifying the load-side output of the WPTL using a rectifier adapted to the high frequency (HF) operation of the WPTL positioned between the WPTL and the load,
wherein the load includes a power factor correction rectifier (PFCR), and
wherein the supply is free of a PFCR.

Example 45 pertains to a method for implementing a wireless power transfer (WPT) between an AC supply and a load, the method comprising:
transferring power wirelessly using an inductive wireless power transfer link (WPTL) positioned between the AC supply and the load,
wherein the load includes a high-frequency (HF) rectifier connected in series to a current shaping DC/DC converter via an HF bypass capacitor; and
wherein the supply is free of a PFCR.

Example 46 pertains to a method for implementing a wireless power transfer (WPT) between an AC supply and a load, the method comprising:
transferring power wirelessly using an inductive wireless power transfer link (WPTL) positioned between the AC supply and the load; and
rectifying the load-side output of the WPTL using an active rectifier positioned between the WPTL and the load, wherein the load includes a power factor correction rectifier (PFCR); and wherein the supply is free of a PFCR.

Example 47 pertains to a method for implementing a wireless power transfer (WPT) between a three-phase AC supply and a three-phase load, the method comprising:
transferring power wirelessly using an inductive wireless power transfer link (WPTL) positioned between each phase of the three phase AC supply and the three-phase load; and
rectifying the load-side output of each WPTL using a rectifier adapted to the high frequency (HF) operation of the WPTL positioned between each WPTL and each phase of the three-phase load,
wherein each phase of the three-phase load includes a power factor correction rectifier (PFCR); and wherein the supply is free of a PFCR.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a processor chip or a circuit. As software or algorithm, selected steps of the disclosure could be implemented as a plurality of software instructions being executed by a computer/processor using any suitable operating system. In any case, selected steps of the method and system of the disclosure could be described as being performed by a data processor, such as a computing device for executing a plurality of instructions.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Any digital computer system, unit, device, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may be directly loadable into an internal memory of a digital computer, comprising software code portions for performing the methods and/or processes as disclosed herein.

The methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

It should be understood that where the claims or specification refer to “a” or “an” element and/or feature, such reference is not to be construed as there being only one of that element. Hence, reference to “an element” or “at least one element” for instance may also encompass “one or more elements”.

Unless otherwise specified, the terms ‘about’ and/or ‘close’ with respect to a magnitude or a numerical value may imply to be within an inclusive range of −10% to +10% of the respective magnitude or value.

It is important to note that the method may include is not limited to those diagrams or to the corresponding descriptions. For example, the method may include additional or even fewer processes or operations in comparison to what is described herein. In addition, embodiments of the method are not necessarily limited to the chronological order as illustrated and described herein.

Unless otherwise stated or applicable, the use of the expression “and/or” between the last two members of a list of options for selection indicates that a selection of one or more of the listed options is appropriate and may be made, and may be used interchangeably with the expressions “at least one of the following”, “any one of the following” or “one or more of the following”, followed by a listing of the various options.

As used herein, the phrase “A,B,C, or any combination of the aforesaid” should be interpreted as meaning all of the following: (i) A or B or C or any combination of A, B, and C, (ii) at least one of A, B, and C; and (iii) A, and/or B and/or C. This concept is illustrated for three elements (i.e., A,B,C), but extends to fewer and greater numbers of elements (e.g., A, B, C, D, etc.).

It is appreciated that certain features of the invention, which are, for clarity, described in the context of separate embodiments or example, may also be provided in combination in a single embodiment. Conversely, various features of the invention, which are, for brevity, described in the context of a single embodiment, example and/or option, may also be provided separately or in any suitable subcombination or as suitable in any other described embodiment, example, or option of the invention. Certain features described in the context of various embodiments, examples and/or options are not to be considered essential features of those embodiments, unless the embodiment, example and/or option is inoperative without those elements.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

While the invention has been described with respect to a limited number of embodiments, these should not be construed as limitations on the scope of the invention, but rather as exemplifications of some of the embodiments.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations and embodiments described.

What is claimed is:

1. A wireless power transfer (WPT) system comprising:
a wireless power transfer link (WPTL); and
on a load-side of the WPTL, a high frequency (HF) rectifier positioned between the WPTL and a load,
wherein the load includes a power factor correction rectifier (PFCR).

2. The system of claim 1, wherein PFCR is implemented with one of the following circuitry topologies:
bridgeless topology, totem pole topology, and a rectifier-DC/DC topology.

3. The system of claim 1, wherein the high frequency rectifier is connected in series to the input of the PFCR via an HF bypass capacitor.

4. (canceled)

5. (canceled)

6. The system of claim 1, wherein the WPTL is operated in load independent voltage output (LIVO) mode.

7. The system of claim 1, further including, on a supply-side of the WPTL, an AC power supply, wherein the AC power supply and supply-side of the WPTL are connected without power factor correction circuitry.

8. The system of claim 1, wherein the WPTL includes a DC/AC converter and primary and secondary coils.

9. The system of claim 1, wherein the PFCR is an off-the-shelve PFCR.

10. A wireless power transfer (WPT) system comprising:
a wireless power transfer link (WPTL) positioned between a supply and a load; and
wherein the load includes an HF rectifier connected in series to a current shaping DC/DC converter via an HF bypass capacitor.

11. The system of claim 10, wherein the WPTL is operated in load independent voltage output (LIVO) mode.

12. The system of claim 10, further including, on a supply-side of the WPTL, an AC power supply, wherein the AC power supply and supply-side of the WPTL are connected without power factor correction circuitry.

13. The system of claim 10, wherein the WPTL includes a DC/AC converter and primary and secondary coils.

14. A wireless power transfer (WPT) system comprising:
a wireless power transfer link (WPTL) operating in load independent current output (LICO) mode;
on a load-side of the WPTL, an active rectifier positioned between the WPTL and a load,
wherein the load includes a power factor correction rectifier (PFCR).

15. The system of claim 14, wherein the PFCR is implemented by one of the following selected topologies:
a) a low frequency (LF) rectifier and a current shaping DC/DC converter connected to the output of the LF rectifier;
b) a bridgeless topology, and
c) a totem pole topology.

16. (canceled)

17. (canceled)

18. (canceled)

19. (canceled)

20. (canceled)

21. A three-phase wireless power transfer (WPT) system comprising:
a wireless power transfer link (WPTL) for each phase; and
on a load-side of the WPTL for each phase, a high frequency (HF) rectifier positioned between the WPTL and a three-phase load,
wherein each phase of the three-phase load includes a power factor correction rectifier (PFCR).

22. The system of claim 21, wherein the PFCR comprises one of the following topologies:
a rectifier-DC/DC topology; a bridgeless topology; a totem pole topology.

23. The WPT of claim 21, wherein the PFCRs employed are off-the-shelve PFCRs.

24. The system of claim 21, wherein, in each phase, the high frequency rectifier is connected in series to the input of the PFCR via an HF bypass capacitor.

25. (canceled)

26. (canceled)

27. (canceled)

28. The system of claim 21, wherein the WPTL in each phase is operated in load independent voltage output (LIVO) mode.

29. The system of claim 21, further including, on a supply-side of the WPTL in each phase, a three-phase AC power supply, wherein the three-phase AC power supply and supply-side of the WPTL are connected without power factor correction circuitry.

30. The system of claim 21, wherein the WPTL includes a DC/AC converter and primary and secondary coils.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)
